(19) United States
(12) Patent Application Publication
(10) Pub. No.: US 2005/0235506 A1
(43) Pub. Date: Oct. 27, 2005

(54) Method for profilometer position registration

(75) Inventors: Randolph C. Brost, Albuquerque, NM (US); Stephen C. Meissner, West Henrietta, NY (US)

Correspondence Address: Pamela R. Crocker;Patent Legal Staff, Eastman Kodak Company, 343 State Street, Rochester, NY, 14650-2201, US

(73) Assignee: Eastman Kodak Company

(21) Appl. No.: 10/829,898

(22) Filed: Apr. 22, 2004

(51) Int. Cl. G01B 5/004

(52) U.S. Cl. 33/502

(57) ABSTRACT

A method for expressing disparate profilometer (20) measurements in a common coordinate system, comprises the steps of providing a work-piece holder (10) with at least two reference features (14) having surfaces and centers; fixing a work-piece (16) in the work-piece holder (10); scanning (S1) the surfaces of the reference features (14); and determining the centers of the reference features (14) in at least an x₁, y₁ coordinate system. The next steps are scanning (S2) a surface of the first work-piece (16) and obtaining a measurement result; and transforming (S3) the measurement result into an x_{g}, y_{g} global coordinate system. The next step is repeating the above steps for successive work-piece surfaces, or successive work-pieces or the same work-piece at different times. The final steps are combining (S4) the measurement results in x_{g}, y_{g} global coordinate system and computing desired output.

### FIELD OF THE INVENTION

The invention relates generally to profilometer measurements, and more particularly to a method of identifying positional relationships between multiple profilometer scans.

### BACKGROUND OF THE INVENTION

Profilometers are often used to measure planar surfaces and surfaces of revolution. Scanning profilometers can measure an entire surface area providing significantly more information than linear trace profilometers. In situations where different measurements of a given object must be compared, such as before and after a machining operation, it is necessary to identify the position relationship between multiple profilometer scans. This position relationship is necessary to determine the change in given points on the object surface. This is a difficult problem for two reasons. First, symmetries in the surface may prevent the use of the surface itself to determine relative position and orientation. Second, drift in the profilometer prevents the use of absolute coordinates to register measurements made at different points in time. It is therefore desirable to have a method for measuring that can use the surface being measured to determine relative position and orientation, and can use absolute coordinates to register measurements made at different points in time.

U.S. Pat. No. 6,072,569 to Bowen discloses a method for measuring opposite sides of a given optical component and a mathematical procedure for expressing those measurements in a common coordinate system so that the wedge and decenter of the optical component can be determined. Opposite sides of an optical component are scanned while mounted in a test fixture which is turned over to expose the opposed sides to the profilometer. Turning a test fixture over for measuring takes time thereby decreasing productivity and increasing cost. It is desirable to take measurements without having to adjust the test fixture.

### SUMMARY OF THE INVENTION

The present invention is directed to overcoming one or more of the problems set forth above. According to one aspect of the invention, a method for expressing disparate profilometer measurements in a common coordinate system, comprising the steps of providing a work-piece holder with at least two reference features having surfaces and centers; fixing the work-piece in the work-piece holder; scanning the surfaces of the reference features; and determining the centers of the reference features in at least an x₁, y₁ coordinate system. The next steps are scanning a surface of a first work-piece and obtaining a measurement result; and transforming the measurement result into an x_{g}, y_{g} global coordinate system. The next step is repeating the above steps for successive work-piece surfaces, or successive work-pieces or the same work-piece at different times. The final steps are combining the measurement results in x_{g}, y_{g} global coordinate system and computing desired output.

### BRIEF DESCRIPTION OF THE DRAWINGS

FIG. 1 is an apparatus for holding a workpiece in a fixed position relative to reference spheres;

FIG. 2 is diagrammatic view of a profilometer with reference spheres and a nest for holding a work-piece; and

FIG. 3 is a flowchart illustrating a method for expressing disparate profilometer measurements in a common coordinate system.

### DETAILED DESCRIPTION OF THE INVENTION

Referring to FIG. 1, a mounting platform 10 has a base member 12 with at least two, but preferably three, reference spheres 14 mounted therein with a surface of each sphere protruding above the surface of the base member. Two spheres are sufficient when tilt is not one of the parameters to be determined by the measurement to be made. Spheres are preferred, but other reference features could be used, such as cylinders, cones, cubes and the like. Such a mounting platform is more fully described in U.S. Pat. No. 6,072,569, the disclosure of which is incorporated herein by reference. A work-piece 16 is held on the platform in a fixed position so that its position does not change relative to the reference spheres between measurements.

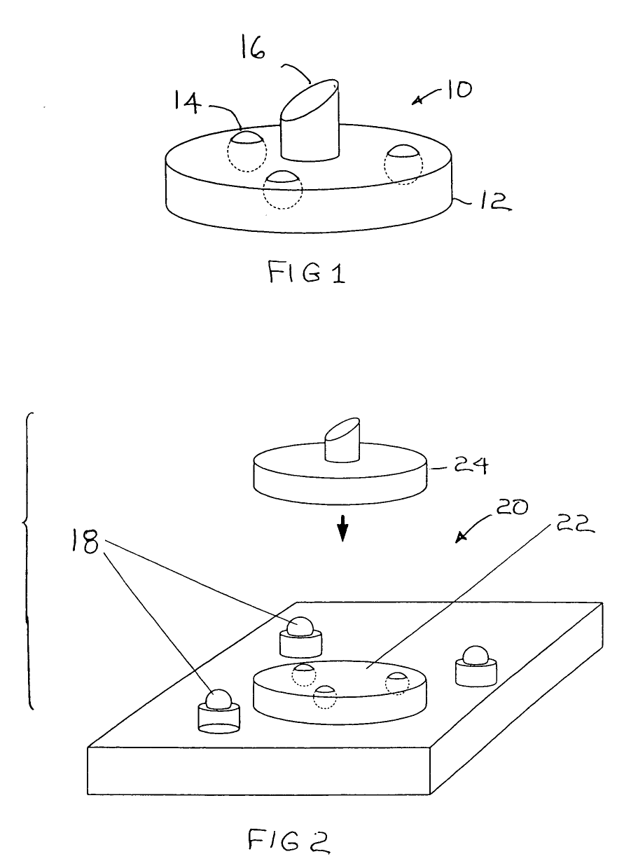

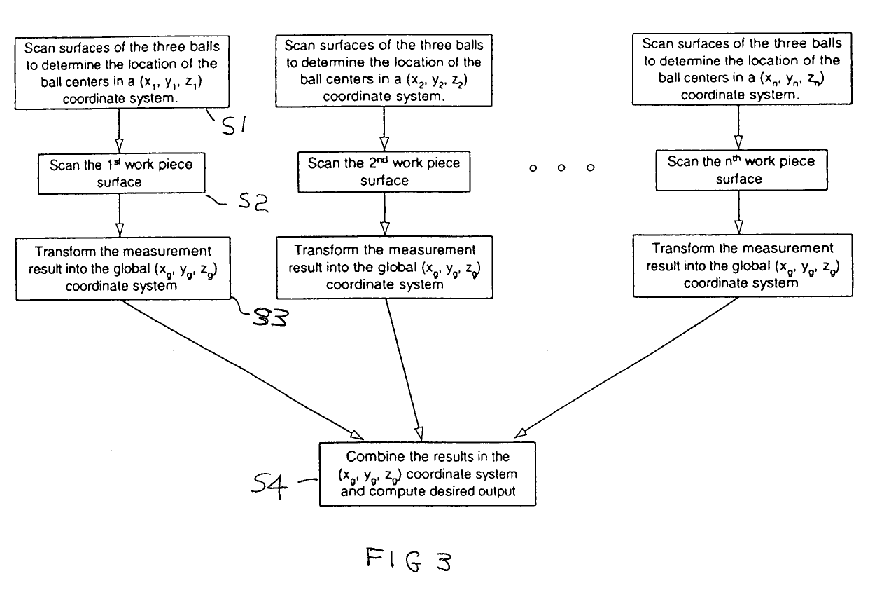

Referring to FIG. 2, sometimes it is not practical to place the reference spheres on the mounting platform because of cost or process constraints. In such a situation, reference spheres 18 may be mounted in the profilometer 20 with a nest 22 to locate the mounting platform 24 in a repeatable position. Such a nest and mounting platform are more fully described in U.S. Pat. No. 6,072,569, the disclosure of which is incorporated herein by reference.

Referring to FIG. 3, a method for expressing disparate profilometer measurements in a common coordinate system includes providing a work-piece holder. The work-piece holder has at least two reference features with surfaces and centers. The work-piece is held in fixed position in the work-piece holder so that its position does not change relative to the reference features between measurements. With the work-piece fixed in the work-piece holder, the next step, S1, is scanning the surfaces of the reference features and determining the centers of the reference features in at least an x₁, y₁ coordinate system. Where a three coordinate axis system is used instead of a two coordinate axis system, then three reference features are required for an x₁, y₁, z₁ coordinate system. The scan identifies enough measurement points to allow the centers to be identified by numerical fitting procedures. The coordinates of the reference feature centers identified in S1 are used to compute the transform of the current fixture position relative to some reference position.

The next step, S2 is scanning a surface of a first work-piece and obtaining a measurement result. Transforming the measurement result into an x_{g}, y_{g} global coordinate system is step S3. The measured points are displaced using the transform form S1. Steps S1 to S3 are repeated for successive work-piece surfaces, for successive work-pieces or for the same work-piece at different times. Steps S3 places all measured points in a single, uniform coordinate system where surface features may be directly compared. The final step, S4, is combining the measurement results in the x_{g}, y_{g} global coordinate system and computing the desired output.

The present invention is a method for expressing disparate profilometer measurements in a common coordinate system. Using this method allows measuring the same surface at different points in time, such as before and after machining, to produce a point to point comparison between the before and after surfaces. The method permits executing one measurement to determine the position of a machine tool's coordinate axes on the work holder and a later measurement of a work-piece surface, expressing the surface measurement relative to the machine tool axis. Also, the method allows measuring the datums on a work-piece and expressing separate surface measurements relative to the datums.

The present invention combines multiple general profilometer scans in a common coordinate system. The method is useful when a numerical fit cannot be performed because there is no mathematical model of the nominal surface. It is useful for optical surfaces with weak aspheric departure where numerical fitting techniques produce poor results because of numerical ambiguities. It is useful when it is desired to compare two surface measurements directly, point-to-point. It is also useful where there is a need to register the measurement relative to other features, such as assembly datums or machine tool axes.

It can now be appreciated that a method for profilometer position registration has been presented; that is, a method for expressing disparate profilometer measurements in a common coordinate system. The method uses a rigid fixture which contains two or more permanent spheres in fixed positions. The work-piece is attached to the fixture and is not removed until all measurements operations are completed. Alternatively, a rigid fixture with two or more spheres and a detachable holder for the work-piece with a mechanism that allows the removal and replacement of the holder while achieving a precisely repeatable position could be used. The profilometer first scans the spheres, obtaining enough measurement points to allow the sphere center to be identified by numerical fitting. The resulting coordinates of the sphere centers are used to compute the transform of the current fixture position relative to some reference position. The work-piece is then scanned and the resulting measured points are displaced using this transform. Applying this method to each required surface measurement obtains all points in a single coordinate system where surface features can be compared directly. The method permits the correct comparison of multiple measurements of a given work-piece made at different points in time assuring that compared points correspond to identical points on the surface of the real object.

The method is effective without the addition of global position registration on the profilometer, which is expensive and ultimately limited in precision.

The invention has been described with reference to a preferred embodiment. However, it will be appreciated that variations and modifications can be effected by a person of ordinary skill in the art without departing from the scope of the invention. For example, step S2, which is scanning a surface of a first work-piece and obtaining a measurement result, may be performed before step S1, which is scanning the surfaces of the reference features and determining the centers of the reference features in at least an x₁, y₁ coordinate system.

The invention has been described in detail with particular reference to certain preferred embodiments thereof, but it will be understood that variations and modifications can be effected within the spirit and scope of the invention.

### PARTS LIST

10 mounting platform
12 base member
14 reference spheres
16 work-piece
18 reference spheres
20 profilometer
22 nest
24 mounting platform

1. A method for expressing disparate profilometer measurements in a common coordinate system, comprising the steps of:
(a) providing a work-piece holder with at least two reference features having surfaces and centers;
(b) fixing a first work-piece in the work-piece holder;
(c) scanning the surfaces of the reference features;
(d) determining the centers of the reference features in at least an x₁, y₁ coordinate system;
(e) scanning a surface of a first work-piece and obtaining a measurement result;
(f) transforming measurement result into an x_{g}, y_{g} global coordinate system; and
(g) computing desired output.

2. The method of claim 1 including:
repeating steps (a)-(f) for successive work-piece surfaces; and
combining measurement results in x_{g}, y_{g} global coordinate system and computing desired output.

3. The method of claim 1 including:
repeating steps (a)-(f) for successive work-pieces; and
combining measurement results in x_{g}, y_{g} global coordinate system and computing desired output.

4. The method of claim 1 including:
repeating steps (a)-(f) for same work-piece at different times; and
combining measurement results in x_{g}, y_{g} global coordinate system and computing desired output.

5. The method of claim 1 wherein step (e) is performed before step (c).

6. A method for expressing disparate profilometer measurements in a common coordinate system, comprising the steps of:
(a) providing a work-piece holder with at least two reference features having surfaces and centers;
(b) fixing a first work-piece in the work-piece holder;
(c) scanning the surfaces of the reference features;
(d) determining the centers of the reference features in at least an x₁, y₁ coordinate system;
(e) scanning a surface of the a first work-piece and obtaining a measurement result;
(f) transforming measurement result into an x_{g}, y_{g} global coordinate system;
(g) repeating steps (a)-(f) for one of successive work-piece surfaces, successive work-pieces and same work-piece at different times; and
(h) combining measurement results in x_{g}, y_{g} global coordinate system and computing desired output.

7. The method of claim 6 wherein steps (e) is performed before step (c).

8. A method for expressing disparate profilometer measurements in a common coordinate system, comprising the steps of:
(a) providing a work-piece holder with at least two reference features having surfaces and centers;
(b) fixing a first work-piece in the work-piece holder;
(c) scanning the surfaces of the reference features;
(d) determining the centers of the reference features in an x₁, y₁, z₁ coordinate system;
(e) scanning a surface of the first work-piece and obtaining a measurement result;
(f) transforming measurement result into an x_{g}, y_{g}, z_{g} global coordinate system;
(g) repeating steps (a)-(f) for one of successive work-piece surfaces, successive work-pieces and same work-piece at different times; and
(h) combining measurement results in x_{g}, y_{g}, z_{g} global coordinate system and computing desired output.

9. The method of claim 8 wherein steps (e) is performed before step (c).
